(19) United States
(12) Patent Application Publication
(10) Pub. No.: US 2009/0319539 A1
(43) Pub. Date: Dec. 24, 2009

(54) System for Characterizing Information

(76) Inventors: Joel K. Soppet, Pleasanton, CA (US); Charles Soppet, San Diego, CA (US)

Correspondence Address: FISH & ASSOCIATES, PC;ROBERT D. FISH, 2603 Main Street, Suite 1000, Irvine, CA, 92614-6232, US

(21) Appl. No.: 12/141,727

(22) Filed: Jun. 18, 2008

(51) Int. Cl. G06F 17/30

(52) U.S. Cl. 707/100; 707/E17.009

(57) ABSTRACT

A system and method of characterizing and displaying information displays users and relevant content information in a graphical, nodal format. The users and the content information can be filtered in multiple different ways to make search results more relevant to a user's needs, and related content information can be aggregated to create more reliable records of history.

### FIELD OF THE INVENTION

The field of the invention is database structures.

### BACKGROUND

Unlike books where one can cite the author, publisher, and the date written, information collected from a variety of sources on the Internet often lacks referential integrity that enables the reader to assess the credibility of information provided.

Websites such as www.wikipedia.org accumulate information from multiple sources that are non-citable or not reliable, and use consensus over reliability to assess the credibility of information provided. Additionally, the verification methods used are not transparent since power users and editors are allowed to determine what information is credible and should be displayed in a given article. The Wikipedia website and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Other websites that accumulate information from multiple sources allow every single source to be shown, so that users can determine what information is credible. The website www.urbandictionary.com, for example, displays all definitions of a given word, and allows users to rank the definitions, making the more popular definitions appear first. Thus, the website shows all the information submitted by the users, filters on which definitions are highly ranked by other users, and transparently informs the reader how many other users agreed with that definition. However, additional methods of filtering the information are not available to users. The website itself performs the filtering, and delivers the information to the user using a method that it deems the most useful to the user.

Thus, there is still a need for improved systems and methods of collecting information from multiple sources and allowing users to filter information.

### SUMMARY OF THE CURRENT INVENTION

The present invention provides apparatus, systems and methods in which content information inputted by users can be filtered and aggregated in multiple different ways. The computer contains software which displays a map showing a graphical relationship between the users as nodes and can filter the content information based upon relationships or words included in the content.

Users can be any logical entity, for example a natural person or a corporation. The system can be configured to display the users in any suitable relationship format, but is preferably configured to display the users as nodes that are related to one another, for example in a genealogical family tree, by familial relationship, social networking relationship, an employment networking relationship, an ethnic relationship, a country of origin, an educational degree, a grade point average, an attendance at an educational institution, an employment in an organization, a position in the organization, a length of employment in an organization, a career path, financial information, a username, an IP address, a URL, or even a rating from other users. Using such a system map, the credibility of content information entered from a user can be measured based upon their relationship with that person or their relationship with other people in addition to their individual attributes.

The content information in the system associated with a user can be any information that can be associated with the user, for example descriptions of the user, descriptions of events witnessed by the user (i.e. tragedies, social milestones, ownership, a pending events), and attributes of credibility. Descriptions of an event can be filtered by certain shared characteristics of the event, for example viewpoints of the event, family members who described the event, credibility information other users gave of the event, or types of events. Using such filters, a user can aggregate multiple descriptions by electronically identifying missing elements within different descriptions and aggregating content from sources that user chooses.

Content information in the system can be displayed and filtered in many different ways. For example, the system can also remove or change the color of user nodes, center the map on a node, zoom in and out on the map, or even change the location and orientation of the nodes. The content information displayed can be filtered on any content information provided by the user, including relationships with other users.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a database structure with information on multiple users.

FIG. 2 is a graphical representation of a subset of users and corresponding information in the database.

FIG. 3 is another graphical representation of a subset of users and corresponding information in the database.

FIG. 4 shows different logical groupings of information supplied by the users.

FIG. 5 is a timeline produced by information gleaned from the database.

### DETAILED DESCRIPTION OF THE DRAWING

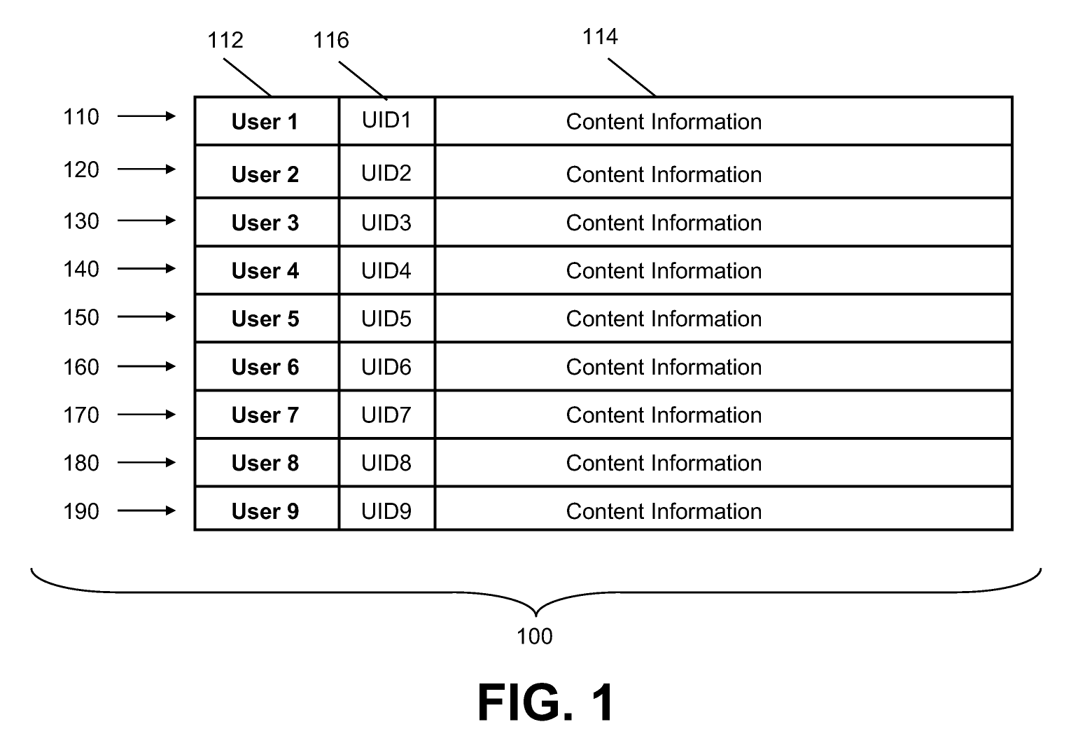

In FIG. 1, a database of information 100 containing information about multiple users 110, 120, 130, 140, 150, 160, 170, 180, and 190 is shown. Each user typically has a unique user identifier 112 and associated content information 114 that is preferably received from that user, but can be received from any appropriate source if desired. The content information can relate to any suitable data for the system, for example descriptions of the user, freeform text describing events that the user has witnessed, or photos from a trip the user went on. The content information is typically collected using an electronic input interface, which can be connected directly to the system server, but is preferably collected through an internet website that provides a user interface for each connected user. Users can preferably set privacy rights for the content information, making the contact information publicly available to all users, available to only some users, available to only certain applications on the system, or available only to him/herself.

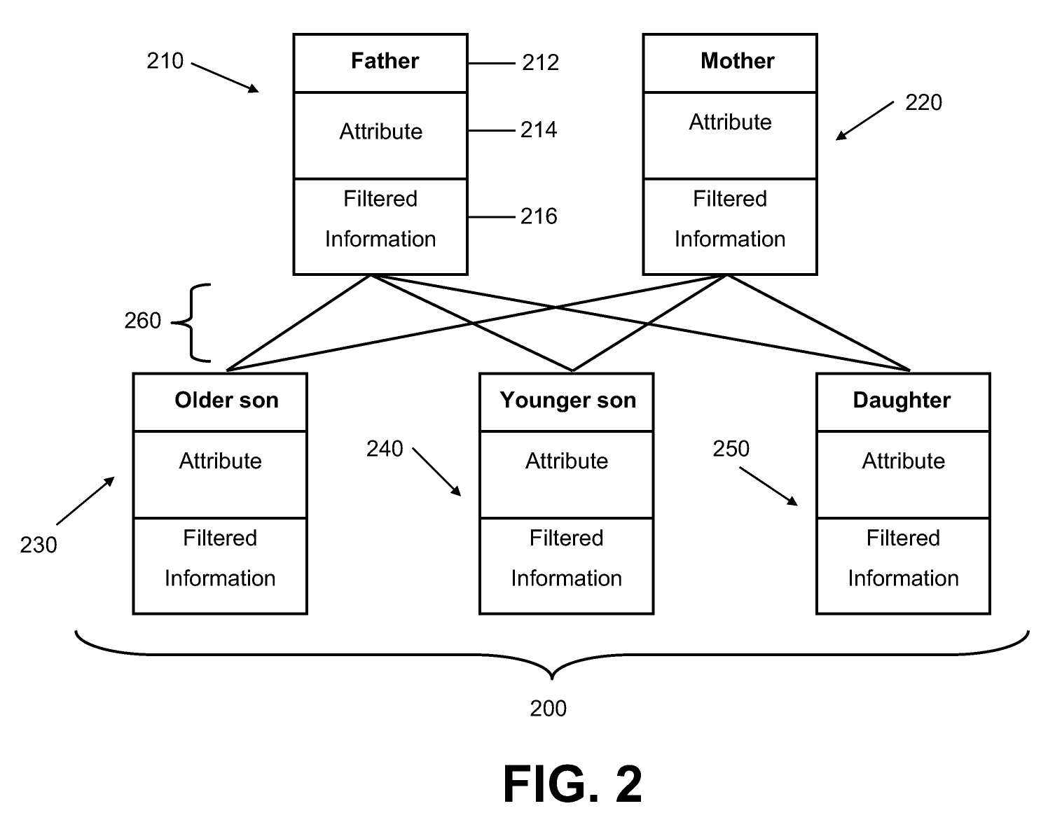

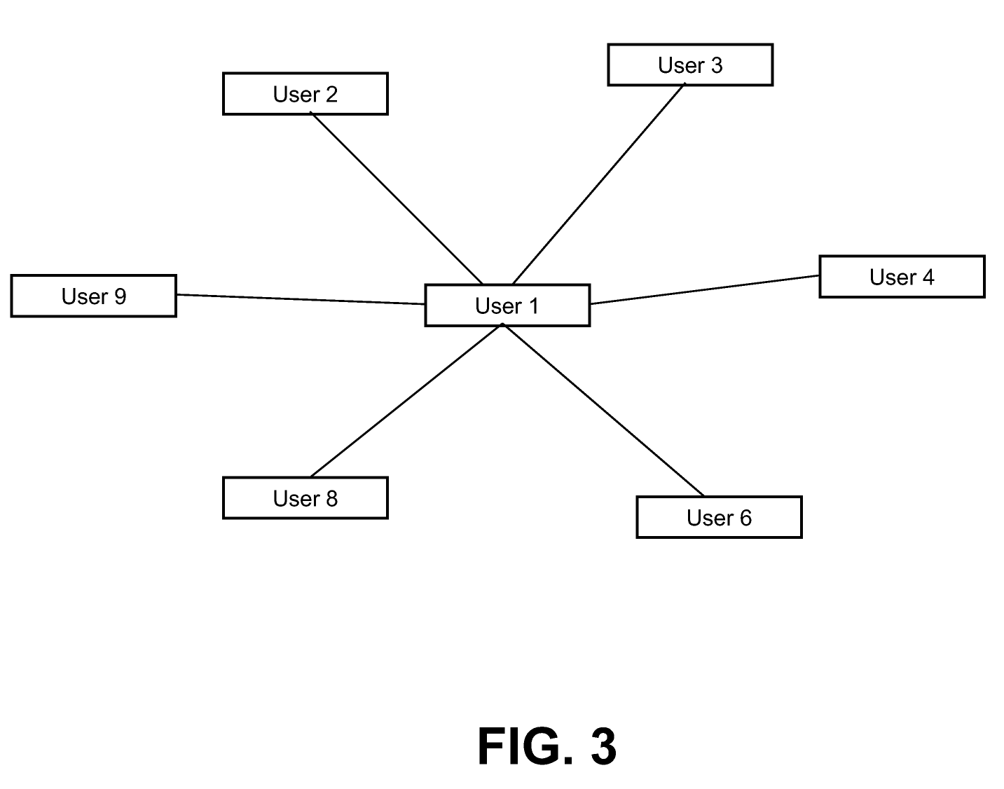

While the content information can all be displayed in a list form, it is preferred that the users be depicted as nodes in a graphical representation of a relationship among the users, filtering for only desired information. In FIG. 2, graphical representation 200 shows users 210, 220, 230, 240, and 250 attached by connectors 260. The users are depicted in a genealogical family tree format. While the relationship in graphical representation 200 is a familial relationship, other relationships could be drawn between users depicted, for example an employment relationship of work colleagues, a school relationship of classmates, or an entire social networking relationship depicting family members, colleagues, classmates, and other acquaintances. The nodes could be filtered, or could be colored, textured, patterned, or labeled based upon relationships or attributes, and the connectors could be colored or otherwise differentiated from one another to show the type of relationship between the connected nodes. The graphical interface can preferably be manipulated as appropriate. For example in FIG. 3, a graphical interface showing all of User 1's acquaintances is shown, with User 1 in the middle of the map.

It is contemplated that the displayed nodes can be filtered not only by relationship, but by attributes of the individual users, for example name, pseudonyms, type of user, surname, family relationship, ethnicity, country of origin, educational degree, grade point average, attendance at an educational institution, employment in an organization, position in the organization, length of employment in the organization, career path, financial information, URL, username, or a rating from other users. Likewise, the filtered information could be filtered in any suitable way, for example a user might want to view content information that other like-minded users wrote on a major tragedy in their lives, whether the information relates to the death of a loved one, the birth of a child, contracting and living with cancer, a building fire on a specified day, living with a certain kind of terminal illness, declaring bankruptcy, filing a lawsuit. Or a user may want to view stories of certain social milestones, for example a first kiss or how to prepare for a marriage or divorce. The user might want to find other users that have similar items of ownership, for example other users that have a certain kind of pet, house, car, or toy. The user may want to get advice for preparing for a pending event, for example a birthday, an anniversary, a subscription ending, or a warranty ending.

Such information could be of great interest to other users, especially to those who are reaching some sort of major impasse and are looking for advice from a trusted source. The source does not have to be trusted, or even known, as some users can preferably post such information anonymously to be searched and used as reference by other users on the system.

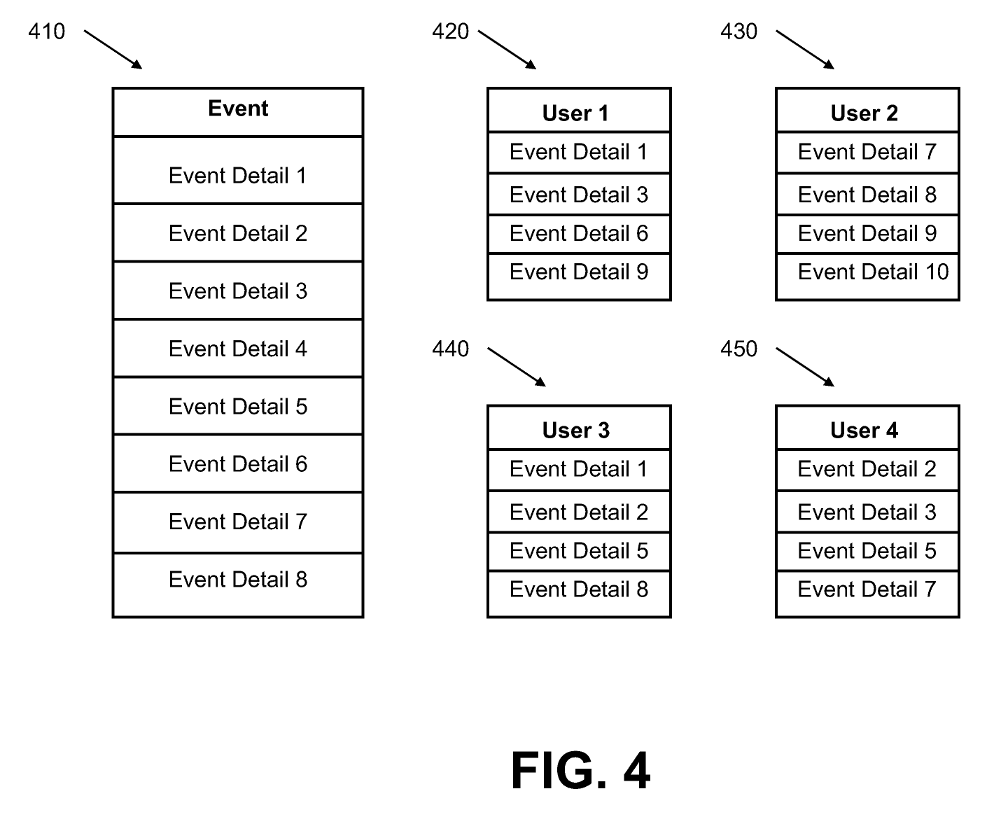

Users can be grouped by common attributes into separate channels, for example one channel could have all CEO's of Fortune 500 companies and another channel could have all people who went to Tibet during the first week of March in 2006. Software on the electronic system (not shown) can preferably run data analysis on the content information associated with each user and can associate groups of content into a collection of record, either automatically or at a user's bequest. The system could query users in a channel to contribute content to a single collection of record, could automatically seek out relevant content information in the database to aggregate, or a user could analyze content information from “trusted users” and aggregate the information him/herself. For example, in FIG. 4, four users 420, 430, 440, and 450 have all contributed content information concerning an event all four users witnessed, and the system aggregated most of the event details from each user into aggregated content 410. The system preferably automatically filters, either based upon corroborating data, or on a “trustworthiness” rating that one or more users have given the users who contributed content information.

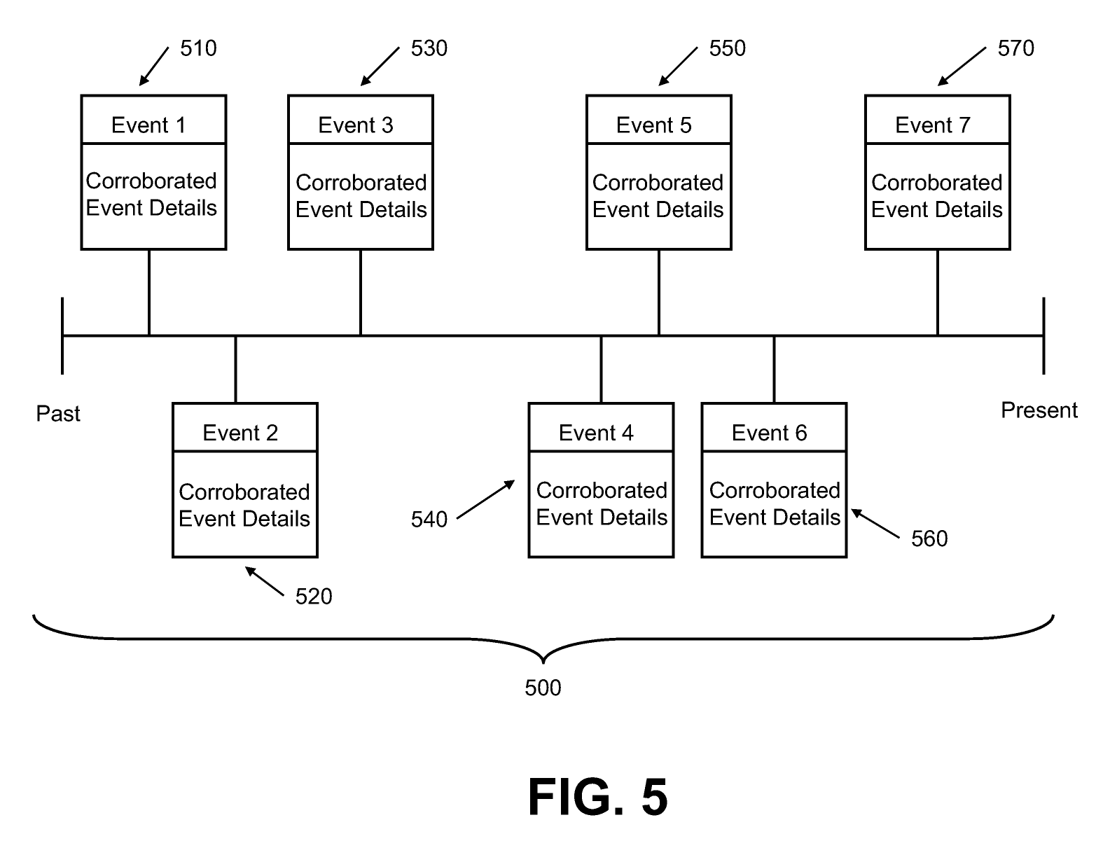

Using such a system, people can corroborate and aggregate stories of a commonly shared event, or merely read reviews of an item of media, for example a book, a movie, a journal article, or a blog. Trusted users who are known to write exemplary reviews can be filtered to be placed on a “hot list” of quality reviews to read every so often. Another contemplated use of the system is to create a personal timeline of events that have been corroborated and aggregated from multiple acquaintances in a user's life. FIG. 5 shows a timeline 500 of multiple events in a user entity's existence. Such a timeline is useful, for example, for those reaching old age and who want to remember important details from history or for a company who wants to have a record of what happened in a successful or a failed project every step of the way.

Thus, specific embodiments and applications of characterizing information have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for characterizing information, comprising:
software operating on a computer, the software including code that provides for an interface that receives content from users;
a map that depicts the users as nodes, and provides a graphical representation of a relationship among the users; and
a filtering mechanism that filters a depiction of the nodes based upon words included in the content.

2. The system of claim 1, wherein the map corresponds to a genealogical family tree.

3. The system of claim 1, wherein the relationship comprises at least one of a familial relationship, a social networking relationship, and an employment networking relationship.

4. The system of claim 1, wherein the filtering mechanism removes of at least some of the nodes.

5. The system of claim 1, wherein the filtering mechanism changes a color of at least some of the nodes.

6. The system of claim 1, wherein the software also includes code that provides for an interface to share content with at least two other users simultaneously.

7. The system of claim 1, wherein the software also includes code that associates groups of users into channels.

8. The system of claim 7, wherein the software also includes code that associates groups of content into a collection of record.

9. The system of claim 8, wherein the software also includes code that provides for an interface that allows users in a channel to contribute content to a collection of record.

10. A method of validating first and second descriptions of an event, comprising:
associating the first and second descriptions with first and second sources, respectively;
associating the first and second sources with first and second credibility attributes, respectively;
providing a list of the descriptions along with identification of the sources, and the corresponding attributes of the sources; and
filtering the list according to at least one of the attributes.

11. The method of claim 10, wherein the event comprises a review of an item of media.

12. The method of claim 10, wherein the attributes are selected from the group consisting of a familial relationship, an ethnic relationship, and country of origin.

13. The method of claim 10, wherein the attributes are selected from the group consisting of employment in an organization, position in the organization, length of employment in the organization, and career path.

14. The method of claim 10, wherein the attributes include a calculated rating based upon posting of previous descriptions.

15. The method of claim 10, wherein the attributes include a URL, IP address, username, and password.

16. A method of aggregating information, comprising:
electronically collecting first and second accounts of the information;
electronically determining extents to which various elements of the information are corroborated;
electronically weighing disparate elements of the information according to a measure of credibility of corresponding sources.

17. The method of claim 16, wherein the information comprises different viewpoints of a given event.

18. The method of claim 16, wherein the information comprises accounts of different events with shared characteristics.

19. The method of claim 16, further comprising electronically identifying missing elements within the information.

20. The method of claim 16, wherein the information relates to at least one of a tragedy, a social milestone, ownership of an item, and a pending event.
